(19) United States
(12) Patent Application Publication
(10) Pub. No.: US 2009/0243471 A1
(43) Pub. Date: Oct. 1, 2009

(54) ORGANIC ELECTROLUMINESCENT DEVICE

(75) Inventors: Yukinori KAWAMURA, Matsumoto City (JP); Yutaka TERAO, Matsumoto City (JP); Makoto KOBAYASHI, Matsumoto City (JP); Naoyuki KANAI, Matsumoto City (JP); Ryohei MAKINO, Matsumoto City (JP)

Correspondence Address: ROSSI, KIMMS & McDOWELL LLP., 20609 Gordon Park Square, Suite 150, Ashburn, VA, 20147, US

(73) Assignee: FUJI ELECTRIC HOLDINGS CO., LTD., Kawasaki (JP)

(21) Appl. No.: 12/365,162

(22) Filed: Feb. 3, 2009

(30) Foreign Application Priority Data
Feb. 4, 2008 (JP) 2008-024134

(51) Int. Cl. H01J 1/63

(52) U.S. Cl. 313/504

(57) ABSTRACT

An organic EL device is disclosed in which the amount of dopant added is easily controlled, and which is able to achieve stable light emission that does not depend on the current density of electrical current passing through the device. The organic electroluminescent device includes a first electrode, an organic electroluminescent layer having a hole injecting and transporting layer, an organic emissive layer and an electron injecting and transporting layer, and a second electrode. The organic emissive layer has an inner layer interposed between two outer layers. The outer layers contact the hole injecting and transporting layer and the electron injecting and transporting layer, respectively. The two outer layers are composed of a host material and a first fluorescent dopant, and the inner layer is composed of a host material, a first fluorescent dopant and a second fluorescent dopant. The first fluorescent dopant has a larger bandgap than the second fluorescent dopant.

### BACKGROUND OF THE INVENTION

A. Field of the Invention

The present invention relates to an organic electroluminescent (EL) device, and in particular an organic EL device which has a high definition, high visibility and excellent environmental resistance, and which is adapted for use in color conversion-type organic EL displays that enable excellent multicolor display.

B. Description of the Related Art

One way to achieve a full-color display using organic EL devices is the color conversion method. In a color conversion-type color display, organic EL devices which emit blue or blue-violet light are used as the light sources for the individual pixels. At blue (B) pixels, a blue color filter is used, allowing the blue light to pass through; at red (R) pixels, a color conversion layer is used to carry out wavelength conversion and thereby obtain red light. At green (G) pixels, depending on the emission color of the organic EL device employed, either a green color filter is used to allow green light to pass through or a color conversion layer which emits green light is used, thereby obtaining a green light.

An organic EL device may be shared as the common light source for the respective RGB pixels. When the organic EL device is used as a color display, it is important that the driving current for each RGB pixel when white color is to be displayed be as uniform as possible. If the driving currents at the time of white lighting differ substantially among the RGB pixels, when the display has been lit for an extended period of time, the brightness drop-off ratio at the respective RGB pixels will change, resulting in a loss of color balance. This is a major defect with respect to color reproducibility, especially color reproducibility during prolonged use.

There is some degree of margin in the respective brightness of red regions, green regions and blue regions in the light emission by organic EL devices used in color conversion-type color displays. In order for the driving currents during white lighting to be uniform, the balance in the brightness of the respective RGB regions in the organic EL device must be corrected. This problem is generally addressed through efforts that involve adding a trace amount (0.1% or less) of a red-emitting guest or dopant to the emissive layer of the organic EL device, thereby broadening the emission spectrum of the organic EL device and improving the balance among the respective RBG regions.

For example, an organic emissive layer which is composed of a blue-emitting layer and a green-emitting layer doped with a red-emitting guest or dopant has been proposed (see Japanese Patent Application Laid-open No. H7-142169). In this document, it is preferable for the doping amount of the red-emitting guest or dopant to be from 10⁻³ to 10 mol %.

An organic EL device in which an organic emissive layer composed of one or a plurality of bands is doped with a plurality of light-emitting dopants, at least one of which emits phosphorescent light, has also been proposed (see Japanese Patent Application Laid-open No. 2004-522276).

However, in a method where doping with a trace amount of a red-emitting guest or dopant is carried out, because the amount of addition is very small, controlling the amount of dopant added is a challenge. Problems with this approach are a greater variation in the characteristics within the light-emitting plane of a single organic EL device, and a greater variation in performance between production lots.

In cases where an organic emissive layer having a multilayer structure is employed, when the density of the current passing through the organic EL device changes, the position where excitons are emitted due to the recombination of hole-electron pairs varies, which may result in large changes in both the position of the emission maximum and the brightness at the emission maximum.

The present invention is directed to overcoming or at least reducing the effects of one or more of the problems set forth above.

### SUMMARY OF THE INVENTION

Therefore, to resolve the above problems, it is desirable to provide an organic EL device wherein the amount of dopant added is easily controlled and which is able to achieve stable light emission that does not depend on the current density of electrical current passing through the device.

The organic EL device of the present invention is an organic electroluminescent device which includes a first electrode, an organic electroluminescent layer having a hole injecting and transporting layer, an organic emissive layer and an electron injecting and transporting layer, and a second electrode. In the inventive organic EL device, the organic emissive layer has two outer layers in contact with either the hole injecting and transporting layer or the electron injecting and transporting layer, and has an inner layer interposed between the two outer layers. The two outer layers are composed of a host material and a first fluorescent dopant, and the inner layer is composed of a host material, a first fluorescent dopant and a second fluorescent dopant. The bandgap of the first fluorescent dopant is larger than that of the second fluorescent dopant. It is desirable here for each of the two outer layers to have a thickness of at least 5 nm. Also, the two outer layers of the organic emissive layer may be formed by the co-vapor deposition of the host material and the first fluorescent dopant, and the inner layer of the organic emissive layer may be formed by the co-vapor deposition of the host material, the first fluorescent dopant and the second fluorescent dopant.

By employing the above arrangement, the fluorescent dopants, especially the second fluorescent dopant, can be added in amounts that are one order of magnitude larger than for uniform doping of the entire organic emissive layer, thereby facilitating control of the amount of addition. This makes it possible to suppress both variations in characteristics within the light-emitting plane of the organic EL device, and variations in performance between production lots. Moreover, by having the position where the second fluorescent dopant is added be the inner layer of the organic emissive layer, and isolating this from the interfaces with the hole injecting and transporting layer and the electron injecting and transporting layer, a stable emission spectrum having minimal current density dependence can be obtained.

### BRIEF DESCRIPTION OF THE DRAWINGS

The foregoing advantages and features of the invention will become apparent upon reference to the following detailed description and the accompanying drawings, of which:

FIG. 1 is a cross-sectional view of an organic EL device according to the present invention.

FIG. 2 is a graph showing the current density dependence of the emission spectrum for the organic EL devices produced in Comparative Example 1.

FIG. 3 is a graph showing the current density dependence of the emission spectrum for the organic EL devices produced in Comparative Example 2.

FIG. 4 is a graph showing the current density dependence of the emission spectrum for the organic EL devices produced in Example 1.

FIG. 5 is a graph showing the current density dependence of the emission brightness at 576 nm for organic EL devices produced in Example 1 and Comparative Examples 1 and 2.

### DETAILED DESCRIPTION OF SPECIFIC EMBODIMENTS

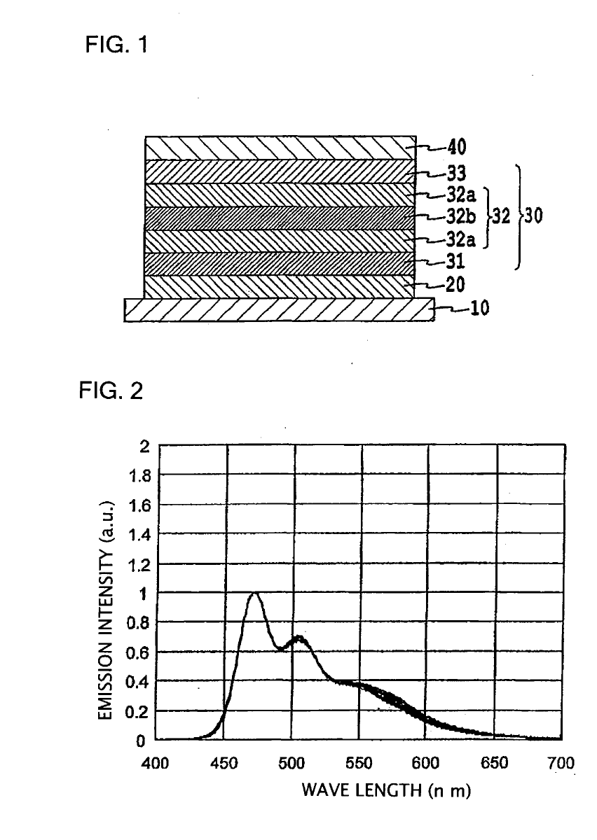

FIG. 1 shows an example of an organic EL device according to the present invention. In the organic EL device of the invention, substrate 10 has layered thereon, in order: first electrode 20, hole injecting and transporting layer 31, organic emissive layer 32, electron injecting and transporting layer 33, and second electrode 40. Organic emissive layer 32 is composed of two outer layers 32a which contact either the hole injecting and transporting layer or the electron injecting and transporting layer, and inner layer 32b interposed between two outer layers 32a. In the example shown in FIG. 1, first electrode 20 is an anode and second electrode 40 is a cathode.

Substrate 10 may be transparent or opaque, and may be formed using, for example, glass, silicon, ceramic, various types of plastic or various types of film. As described subsequently, when manufacturing an organic EL device having a plurality of independently controllable light-emitting areas, a plurality of switching elements may be provided at positions corresponding to the light-emitting areas of the organic EL device on the surface of substrate 10. The plurality of switching elements may be any elements known in the art, such as thin-film transistor (TFT) or metal-insulator-metal (MIM) elements. Also, wiring, drive circuits and the like may additionally be provided on the surface of substrate 10 for the purpose of driving the organic EL device.

Of first electrode 20 and second electrode 40, one is an anode and the other is a cathode. First electrode 20 and second electrode 40 may be transparent or reflective (non-transmitting), provided one of them is transparent. A transparent electrode may be formed using indium-tin oxide (ITO), tin oxide, indium oxide, indium-zinc oxide (IZO), zinc oxide, zinc-aluminum oxide, zinc-gallium oxide, or a clear, conductive metal oxide obtained by the addition of a dopant such as fluorine or antimony to any of the above oxides. A reflective electrode may be formed using a metal, amorphous alloy or microcrystalline alloy having a high reflectance. Examples of high-reflectance metals include aluminum, silver, molybdenum, tungsten, nickel and chromium. Examples of high-reflectance amorphous alloys include NiP, NiB, CrP and CrB. An exemplary high-reflectance microcrystalline alloy is NiAl.

Taking into consideration the ease of injecting holes, it is desirable that the electrode used as the anode (either first electrode 20 or second electrode 40) be made transparent. However, in cases where a reflective anode is desired, an assembly composed of a layer made of the above-described reflective layer material and a layer made of the above-described clear, conductive metal oxide may be used as the anode.

The electron injection efficiency can be increased by providing a cathode buffer layer at the interface between the electrode used as the cathode (either first electrode 20 or second electrode 40) and organic EL layer 30. The cathode buffer layer may be formed of an alkali metal such as lithium, sodium, potassium or cesium, an alkaline earth metal such as barium or strontium, a rare earth metal, an alloy containing such metals, or a fluoride of such metals. In particular, when a transparent cathode is desired, to ensure transparency, it is desirable that the thickness of the anode buffer layer be set to 10 nm or less. On the other hand, when a reflective cathode is desired, the cathode may be formed by using an alloyed material prepared by adding a material having a small work function, such as an alkali metal (e.g. lithium, sodium, potassium) or an alkaline earth metal (e.g., calcium, magnesium, strontium), to the above-described high-reflectance material.

A passive matrix-driven organic EL device having a plurality of independently controllable light-emitting regions can be obtained by having first electrode 20 and second electrode 40 each composed of a plurality of partial electrodes in the shape of stripes, and having the direction in which the partial electrode stripes of first electrode 20 extend intersect (preferably perpendicularly) with the direction in which the partial electrode stripes of second electrode 40 extend. Alternatively, by placing a plurality of switching elements on substrate 10 and dividing first electrode 20 into a plurality of partial electrodes which connect one-on-one with the switching elements, and by having second electrode 40 be a shared electrode of unitary construction, an active matrix-driven organic EL device with a plurality of independently controllable light-emitting regions can be obtained.

First electrode 20 and second electrode 40 may be formed using any means known to the art, such as, depending on the material used, vapor deposition, sputtering, ion plating or laser ablation.

Hole injecting and transporting layer 31 may be formed as a single layer using a material having excellent hole injectability from the anode and a high hole transporting ability. However, it is generally desirable for hole injecting and transporting layer 31 to be formed as two separate layers: a hole injecting layer which promotes the injection of holes from the anode to the organic layer, and a hole transporting layer which transports holes to organic emissive layer 32. When a hole injecting and transporting layer 31 having a two-layer construction is used, it is desirable to adopt a construction in which the hole-injecting layer is placed in contact with the anode and the hole transporting layer is placed in contact with organic emissive layer 32.

The material used to form hole injecting and transporting layer 31 may be a hole transporting material generally employed in organic EL devices, such as a material having a triarylamine moiety, a carbazole moiety or an oxadiazole moiety. Specific examples of hole transporting materials include N,N′-diphenyl-N,N′-bis(3-methylphenyl)-1,1′-biphenyl-4,4′-diamine (TPD), N,N,N′,N′-tetrakis(4-methoxyphenyl)-benzidine (MeO-TPD), 4,4′,4″-tris{1-naphthyl(phenyl)amino}triphenylamine (1-TNATA), 4,4′,4″-tris{2-naphthyl(phenyl)amino}triphenylamine (2-TNATA), 4,4′,4″-tris(3-methylphenylphenylamino)triphenylamine (m-MTDATA), 4,4′-bis{N-(1-naphthyl)-N-phenylamino}biphenyl (NPB), 2,2′,7,7′-tetrakis(N,N-diphenylamino)-9,9′-spirobifluorene (Spiro-TAD), N,N′-di(biphenyl-4-yl)-N,N′-diphenyl-(1,1′-biphenyl)-4,4′-diamine (p-BPD), tri(o-terphenyl-4-yl)amine (o-TTA), tri(p-terphenyl-4-yl)amine (p-TTA), 1,3,5-tris[4-(3-methylphenylphenylamino)phenyl]benzene (m-MTDAPB) and 4,4′,4″-tris-9-carbazolyltriphenylamine (TCTA).

In cases where hole injecting and transporting layer 31 is formed with a layered structure composed of a hole injecting layer and a hole transporting layer, the hole transporting layer may be formed of the above-mentioned hole transporting material and the hole injecting layer may be formed using, for example, a copper phthalocyanine complex (CuPc). Alternatively, the hole injecting layer may be formed using a material obtained by adding an electron-accepting dopant to the above-described hole transporting material (p-type doping). Electron-accepting dopants that may be used include, for example, organic semiconductors such as tetracyanoquinodimethane derivatives. A typical tetracyanoquinodimethane derivative is 2,3,5,6-tetrafluoro-7,7,8,8-tetracyanoquinodimethane (F₄-TCNQ). Alternatively, an inorganic semiconductor such as molybdenum oxide (MoO₃), tungsten oxide (WO₃) or vanadium oxide (V₂O₅) may be used as the electron-accepting dopant.

Electron injecting and transporting layer 33 may be formed as a single layer using a material having excellent electron injectability from the cathode and a high electron transporting ability. However, it is generally desirable for electron injecting and transporting layer 33 to be formed as two separate layers: an electron injecting layer which promotes the injection of electrons from the cathode to the organic layer, and an electron transporting layer which transports electrons to organic emissive layer 32. When an electron injecting and transporting layer 33 having a two-layer construction is used, it is desirable to adopt a construction in which the electron-injecting layer is placed in contact with the cathode and the electron transporting layer is placed in contact with emissive layer 32.

Electron injecting and transporting layer 33 may be formed using, for example, any of the following electron transporting materials: triazole derivatives such as 3-phenyl-4-(1′-naphthyl)-5-phenyl-1,2,4-triazole (TAZ); oxadiazole derivatives such as 1,3-bis[(4-t-butylphenyl)-1,3,4-oxadiazole]phenylene (OXD-7), 2-(4-biphenylyl)-5-(4-t-butylphenyl)-1,3,4-oxadiazole (PBD) and 1,3,5-tris(4-t-butylphenyl-1,3,4-oxadiazolyl)benzene (TPOB); thiophene derivatives such as 5,5′-bis(dimesitylboryl)-2,2′-bithiophene (BMB-2T) and 5,5′-bis(dimesitylboryl)-2,2′:5′,2″-terthiophene (BMB-3T); aluminum complexes such as aluminum tris(8-quinolinolate) (Alq₃); phenanthroline derivatives such as 4,7-diphenyl-1,10-phenanthroline (Bphen) and 2,9-dimethyl-4,7-diphenyl-1,10-phenanthroline (BCP); and silole derivatives such as 2,5-di-(3-biphenyl)-1,1-dimethyl-3,4-diphenylsilacyclopentadiene (PPSPP), 1,2-bis(1-methyl-2,3,4,5-tetraphenylsilacyclopentadienyl)ethane (2PSP) and 2,5-bis-(2,2-bipyridin-6-yl)-1,1-dimethyl-3,4-diphenylsilacyclopentadiene (PyPySPyPy).

In cases where electron injecting and transporting layer 33 has a two-layer construction composed of an electron injecting layer and an electron transporting layer, the electron transporting layer may be formed of the above-described electron transporting material. The electron injecting layer may be formed using, for example, any of the following materials: alkali metal chalcogenides such as Li₂O, LiO, Na₂S, Na₂Se and NaO; alkaline earth metal chalcogenides such as CaO, BaO, SrO, BeO, BaS and CaSe; alkali metal halides such as LiF, NaF, KF, CsF, LiCl, KCl and NaCl; alkaline earth metal halides such as CaF₂, BaF₂, SrF₂, MgF₂ and BeF₂; and alkaline metal carbonates such as Cs₂CO₃. In cases where the electron injecting layer is formed using such materials, it is desirable that the thickness of the electron injecting layer be set to from about 0.5 to about 1.0 nm.

Alternatively, a thin film (thickness, about 1.0 to about 5.0 nm) made of an alkali metal such as lithium, sodium, potassium or cesium, or an alkaline earth metal such as calcium, barium, strontium or magnesium, may be used as the electron injecting layer.

As another alternative, electron injecting and transporting layer 33 which promotes the injection of electrons from the cathode may be formed using a material obtained by doping the above-described electron transporting material with an alkali metal such as lithium, sodium, potassium or cesium, an alkali metal halide such as LiF, NaF, KF or CsF, or an alkali metal carbonate such as Cs₂CO₃.

Organic emissive layer 32 of the present invention is formed from a host material, a first fluorescent dopant and a second fluorescent dopant. In the present invention, “fluorescent dopant” refers to a compound which assumes a singlet excited state on accepting energy from an exciton and emits fluorescence during a transition from the singlet excited state to the ground state. The first fluorescent dopant is a compound for obtaining blue to blue-violet emission, and the second fluorescent dopant is a compound for obtaining red emission. The first fluorescent dopant has a bandgap (E_{g}1) which is larger than the bandgap (E_{g}2) of the second fluorescent dopant. Examples of first fluorescent dopants that may be used include benzothiazole, benzoimidazole and benzoxazole fluorescent brighteners, metal chelated oxonium compounds, styrylbenzene compounds (e.g., 4,4′-bis(2,2′-diphenylvinyl)biphenyl (DPVBi)), and aromatic dimethylidene compounds. Examples of second fluorescent dopants that may be used include known materials such as rubrene, cyanine pigments such as 4-dicyanomethylene-2-methyl-6-(p-dimethylaminostyryl)-4H-pyran, Lumogen F red and Nile Red.

The host material is a compound whose function is to form excitons by the recombination of holes injected from the hole injecting and transporting layer with electrons injected from the electron injecting and transporting layer, and to transfer the energy to the first and second fluorescent dopants. To prevent the cascade transfer via the host material of that energy which was temporarily transferred to the fluorescent dopant, it is desirable for the host material to have a bandgap (E_{g}h) which is larger than both the bandgap of the first fluorescent dopant (E_{g}1) and the bandgap of the second fluorescent dopant (E_{g}2). Host materials which may be used in the present invention include anthracene compounds such as 9,10-di(2-naphthyl)anthracene (β-ADN), 2-methyl-9,10-di(2-naphthyl)anthracene (MADN), 9,10-bis-(9,9-di(n-propyl)fluoren-2-yl)anthracene (ADF) and 9-(2-naphthyl)-10-(9,9-di(n-propyl)-fluoren-2-yl)anthracene (ANF).

Organic emissive layer 32 of the present invention is composed of two outer layers 32a in contact with either hole injecting and transporting layer 31 or electron injecting and transporting layer 33, and inner layer 32b interposed between two outer layers 32a. Outer layers 32a are layers composed of the host material and the first fluorescent dopant. Inner layer 32b is a layer composed of the host material, the first fluorescent dopant and the second fluorescent dopant. In the present invention, outer layers 32a each have a thickness of at least 5 nm, and preferably at least 10 nm.

In organic emissive layer 32 constructed as indicated above, when holes are injected from the hole injecting and transporting layer and electrons are injected from the electron injecting and transporting layer, the injected holes and electrons recombine on host material molecules, generating excitons. As the excitons diffuse through organic emissive layer 32, they transfer energy to fluorescent dopant molecules having a low excitation energy that are present nearby. The fluorescent dopants which have received the energy then emit light of an emission color specific to each dopant. In this mechanism, the excitons diffuse a distance which, while dependent on the type and concentration of the material used, is generally from about 5 nm to about 10 nm.

Excitons are normally formed either at the interface between organic emissive layer 32 and hole injecting and transporting layer 31, or at the interface between organic emissive layer 32 and electron injecting and transporting layer 33. The reason is that, due to the band offset of the highest occupied molecular orbital (HOMO) or the lowest unoccupied molecular orbital (LUMO) that arises between the organic emissive layer and the adjoining layer (either hole injecting and transporting layer 31 or electron injecting and transporting layer 33), the holes and the electrons tend to accumulate near one of the two interfaces. Whether excitons are selectively formed at organic emissive layer 32/hole injecting and transporting layer 31 interface or organic emissive layer 32/electron injecting and transporting layer 33 interface is governed by the hole and electron injection balance, and thus depends on the density of the electrical current passing through the organic EL device.

In a hypothetical case where the same number of first and second fluorescent dopants are present at organic emissive layer 32/hole injecting and transporting layer 31 interface and at organic emissive layer 32/electron injecting and transporting layer 33 interface, the exciton energy selectively transfers to the second fluorescent dopant having a smaller bandgap E_{g}2 than E_{g}1. As a result, the first fluorescent dopant does not emit light, and the second fluorescent dopant selectively emits light. In the prior art, to eliminate the non-uniformity of such emission, it has been necessary to control addition of the second fluorescent dopant having a small E_{g}2 to a very small amount.

Accordingly, in the arrangement according to the present invention, organic emissive layer 32/hole injecting and transporting layer 31 interface or the organic emissive layer 32/electron injecting and transporting layer 33 interface are formed in outer layers 32a composed of the host material and the first fluorescent dopant, and thus have no second fluorescent dopant present. Some of the excitons that have formed at either of the two interfaces thus provide energy to the first fluorescent dopant in outer layers 32a, causing the first fluorescent dopant to emit light. Also, some of the excitons that have formed diffuse from outer layers 32a to the inner layer 32b, providing energy to the second fluorescent dopants present within the inner layer 32b and thereby causing the second fluorescent dopant to emit light. With such a construction having two outer layers 32a which do not contain the second fluorescent dopant and inner layer 32b which contains the second fluorescent dopant, the first and the second fluorescent dopant can both be made to emit light in a good balance.

By separating in this way the positions at which the first and the second fluorescent dopants emit light, the amount of the second fluorescent dopant added can be made an order of magnitude larger than when it is uniformly added throughout a conventional organic emissive layer. In addition, by increasing the amount of addition, it is easier to control the addition amount, making it possible to improve the in-plane distribution of the second luminescent dopant and the variation between production lots. That is, the brightness variation within the luminescent plane of the organic EL device and the brightness variation between lots can be suppressed.

Moreover, because the second fluorescent dopant is not present at two outer layers 32a positioned at organic emissive layer 32/hole injecting and transporting layer 31 interface and at organic emissive layer 32/electron injecting and transporting layer 33 interface, changes in the emission spectrum (i.e., changes in the emission color) due to changes in the exciton-forming position which are dependent on the current density can be suppressed. In the construction of the present invention, although the excitons have formed in outer layers 32a where each of the interfaces are positioned, because light emission by the first fluorescent dopant arises in outer layers 32a at these positions and light emission by the second fluorescent dopant arises due to excitons which have diffused from outer layers 32a to inner layer 32b, the above-described desirable effects and advantages are obtained.

The various layers making up organic EL layer 30, that is, hole injecting and transporting layer 31, organic emissive layer 32, and electron injecting and transporting layer 33, can be formed using any method known to the art, such as vapor deposition. Outer layers 32a and inner layer 32b making up organic emissive layer 32 may be formed by, for example, the co-vapor deposition of specific materials.

### Example 1

First, an IZO film having a thickness of 200 nm was deposited over the entire surface of a glass substrate by a sputtering process. Next, patterning was carried out by a photolithographic process using the commercial resist OFPR-80 (produced by Tokyo Ohka Kogyo Co., Ltd.), thereby forming a transparent first electrode shaped as 2 mm wide stripes.

Next, the glass substrate with the first electrode formed thereon was mounted in a resistance-heating vapor deposition apparatus, and a hole injecting and transporting layer composed of a hole injecting layer and a hole transporting layer was formed. At the time of film formation, the pressure inside the vacuum chamber was reduced to 1×10⁻⁴ Pa. Copper phthalocyanine (CuPc) was vapor deposited, forming a hole injecting layer having a thickness of 100 nm. Next, 4,4′-bis[N-(1-naphthyl)-N-phenylamino]biphenyl (α-NPD) was vapor deposited, forming a hole transporting layer having a thickness of 20 nm.

Next, without breaking the vacuum, an organic emissive layer was formed on the hole injecting and transporting layer. In the present example, β-ADN (E_{g}h=3.0 eV) was used as the host material, DPVBi (E_{g}1=2.8 eV) was used as the first fluorescent dopant, and rubrene (E_{g}2=2.5 eV) was used as the second fluorescent dopant. Initially, the β-ADN and the DPVBi were co-vapor deposited to form a first outer layer having a thickness of 15 nm. At this time, the β-ADN vapor deposition rate was set to 1.9 Å/s, and the DPVBi vapor deposition rate was set at 0.1 Å/s. Next, β-ADN, DPVBi and rubrene were co-vapor deposited to form an inner layer having a thickness of 5 nm. At this time, the β-ADN and DPVBi vapor deposition rates were set to the same value as above, and the rubrene vapor deposition rate was set to 0.01 Å/s. Finally, a second outer layer having a thickness of 15 nm was formed under the same conditions as for the first outer layer. The content of the first fluorescent dopant (DPVBi) in the resulting outer layers and in the inner layer was 5 vol %. The content of the second fluorescent dopant (Rubrene) in the inner layer was 0.5 vol %.

Next, without breaking the vacuum, Alq₃ was vapor deposited on the organic emissive layer, thereby forming an electron injecting and transporting layer having a thickness of 20 nm.

Next, without breaking the vacuum, a second electrode was formed on the electron injecting and transporting layer. Using a mask capable of obtaining 2 mm wide striped shapes extending in a direction perpendicular to the first electrode stripes, Mg/Ag (weight ratio, 10/1) was vapor deposited, giving a second electrode (reflective) having a thickness of 200 nm and shaped as 2 mm wide stripes.

Finally, the resulting assembly was sealed using sealing glass and a UV curing adhesive in a dry nitrogen atmosphere within a glove box (oxygen concentration and moisture concentration were both 10 ppm or less), thereby giving an organic EL device.

### Comparative Example 1

Aside from using the following procedure to form the organic emissive layer, an organic EL device was obtained in the same way as in Example 1. β-ADN, DPVBi and rubrene were co-vapor deposited on the hole injecting and transporting layer, thereby forming an organic emissive layer having a thickness of 35 nm. At this time, the β-ADN vapor deposition rate was set to 1.9 Å/s, the DPVBi vapor deposition rate was set to 0.1 Å/s, and the rubrene vapor deposition rate was set to 0.001 Å/s. The resulting organic emissive layer contained 5 vol % of the first fluorescent dopant (DPVBi), and contained 0.05% of the second fluorescent dopant (rubrene) which had been added uniformly throughout the entire layer.

### Comparative Example 2

Aside from setting the rubrene vapor deposition rate to 0.01 Å/s, the same procedure as in Comparative Example 1 was carried out, thereby giving an organic EL layer. The resulting organic emissive layer contained 5 vol % of the first fluorescent dopant (DPVBi), and contained 0.5% of second fluorescent dopant (rubrene) which had been added uniformly throughout the entire layer.

### Evaluation

Five lots of organic EL devices were manufactured using the above-described procedures for Example 1 and for each of Comparative Examples 1 and 2. A voltage capable of achieving a current density of 0.1 A/cm² was applied to the organic EL devices thus manufactured, a 2×2 mm light-emitting region was observed from the glass substrate side, and the brightness of emission at that time (measurement wavelength, 400 to 700 nm) was measured. The average of the measured values for each of the five lots of organic EL devices in the respective examples was calculated, and the variation in the measured values for the devices in each lot from the average value was determined. The results are shown in Table 1.

TABLE 1
Lot-to-lot variation of organic EL devices

| | Second fluorescent dopant | | |
|---|---|---|---|
| | Amount added (vol %) | Where added | Variation |
| Example 1 | 0.5 | inner layer only | ±5% |
| Comp. Ex. 1 | 0.05 | uniformly throughout | ±20% |
| Comp. Ex. 2 | 0.5 | uniformly throughout | ±15% |

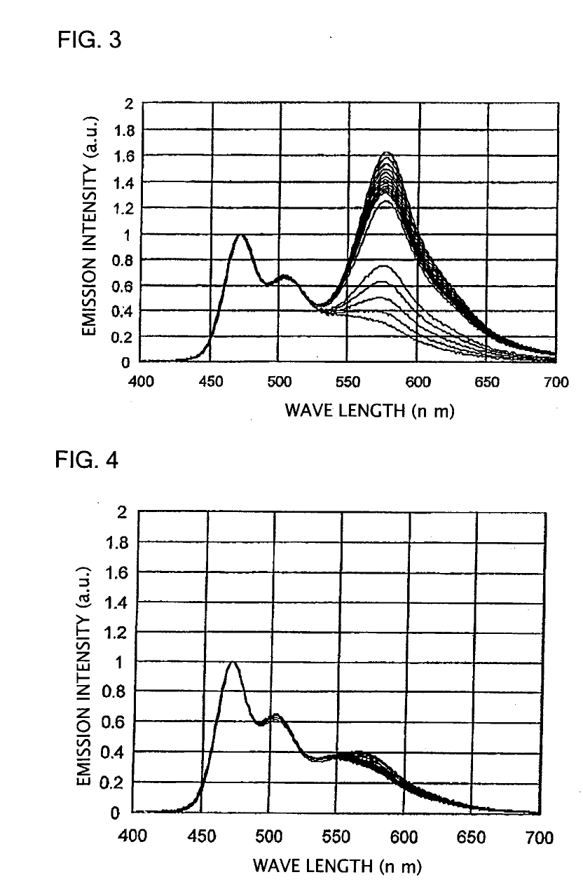

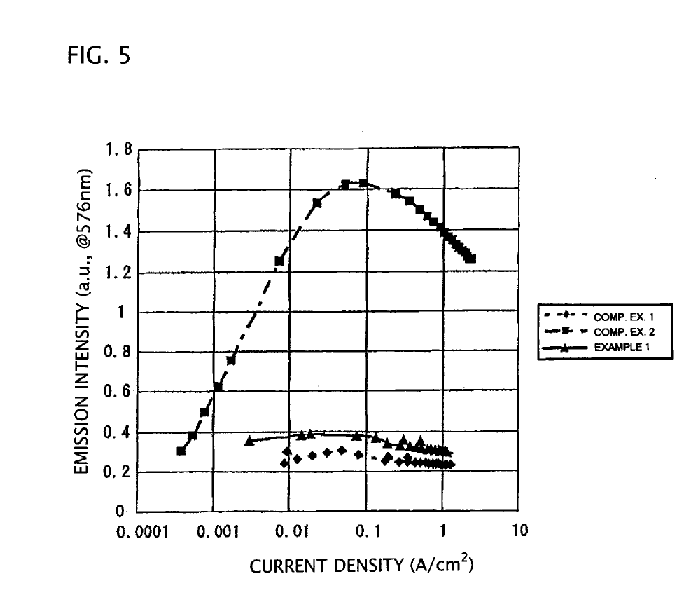

Changes in the emission spectrum when current of various current densities was passed through the organic EL devices obtained in Example 1 of the invention and in Comparative Examples 1 and 2 are shown in FIG. 2 (Comparative Example 1), FIG. 3 (Comparative Example 2) and FIG. 4 (Example 1). The various spectra shown in FIGS. 2 to 4 have been normalized so that the emission intensity at a wavelength of 470 nm is 1. Here, the emission having peaks near a wavelength of 470 nm and near a wavelength of 504 nm is from the first fluorescent dopant (DPVBi), and the emission at a wavelength near 576 nm is from the second fluorescent dopant (rubrene). In addition, FIG. 5 shows the relationship between the current density and the emission intensity at a wavelength of 576 nm (normalized based on the emission intensity at a wavelength of 470 nm).

As is apparent from FIGS. 3 and 5, the organic EL devices of Comparative Example 2, wherein a relatively large amount of the second fluorescent dopant was added throughout the organic emissive layer, underwent large changes in the emission spectrum with changes in current density and thus did not achieve stable emission characteristics. Moreover, as shown in Table 1, the lot-to-lot variation was at a greater than allowable level.

On the other hand, as is apparent from FIGS. 2 and 5, the organic EL devices of Comparative Example 1, wherein the amount of the second fluorescent dopant added throughout the organic emissive layer was made an order of magnitude smaller, underwent small changes in the emission spectrum with changes in current density, exhibiting stable emission characteristics. However, because the amount of the second fluorescent dopant added was very small, as shown in Table 1, the variation in the brightness of emission between lots was large. This shows the difficulty of mass producing organic EL devices having stable emission characteristics.

Compared with the organic EL devices in the above comparative examples, the organic EL devices of Example 1, wherein the organic emissive layer is composed of an inner layer and two outer layer, with the second fluorescent dopant being added only to the inner layer, underwent small changes in the emission spectrum when the current density was varied, and thus exhibited stable emission characteristics. Moreover, it is apparent from Table 1 that the lot-to-lot variation was suppressed.

Thus, an organic EL device has been described according to the present invention. Many modifications and variations may be made to the techniques and structures described and illustrated herein without departing from the spirit and scope of the invention. Accordingly, it should be understood that the devices and methods described herein are illustrative only and are not limiting upon the scope of the invention.

This application is based on and claims priority to Japanese Patent Application JP 2008-024134, filed on Feb. 4, 2008. The disclosure of the priority application in its entirety, including the drawings, claims, and the specification thereof, is incorporated herein by reference.

### EXPLANATION OF REFERENCE NUMERALS

10 SUBSTRATE
20 FIRST ELECTRODE
30 ORGANIC EL LAYER
31 HOLE INJECTING AND TRANSPORTING LAYER
32 ORGANIC EMISSIVE LAYER
32a INNER LAYER
32b OUTER LAYER
33 ELECTRON INJECTING AND TRANSPORTING LAYER
40 SECOND ELECTRODE

What is claimed is:

1. An organic electroluminescent device comprising:
a first electrode,
an organic electroluminescent layer having a hole injecting and transporting layer, an organic emissive layer, and an electron injecting and transporting layer, and
a second electrode,
wherein the organic emissive layer has an inner layer interposed between two outer layers, wherein a first outer layer is in contact with the hole injecting and transporting layer and a second outer layer is in contact with the electron injecting and transporting layer, the two outer layers comprising a host material and a first fluorescent dopant, and the inner layer comprising a host material, a first fluorescent dopant and a second fluorescent dopant, the first fluorescent dopant having a larger bandgap than the second fluorescent dopant.

2. The organic electroluminescent device of claim 1, wherein the two outer layers each have a thickness of at least 5 nm.

3. The organic electroluminescent device of claim 1, wherein the outer layers are formed by co-vapor deposition of the host material and the first fluorescent dopant, and the inner layer is formed by co-vapor deposition of the host material, the first fluorescent dopant and the second fluorescent dopant.

4. The organic electroluminescent device of claim 2, wherein the outer layers are formed by co-vapor deposition of the host material and the first fluorescent dopant, and the inner layer is formed by co-vapor deposition of the host material, the first fluorescent dopant and the second fluorescent dopant.
